(19) United States
(12) Patent Application Publication
(10) Pub. No.: US 2012/0329028 A1
(43) Pub. Date: Dec. 27, 2012

(54) METHOD FOR INTELLIGENT PERSONALIZED LEARNING SERVICE

(75) Inventors: Nam-Sook Wee, Seoul (KR); Jung-Kyo Sohn, Seoul (KR); Doo-Seok Lee, Seoul (KR); Sang-Hoon Park, Incheon (KR)

(73) Assignees: SK TELECOM CO., LTD., Seoul (KR); ISCILAB CORPORATION, Seoul (KR)

(21) Appl. No.: 13/516,210

(22) PCT Filed: Dec. 15, 2009
(86) PCT No.: PCT/KR2009/007480

§ 371 Date: Aug. 27, 2012

(51) Int. Cl. G09B 7/00

(52) U.S. Cl. 434/336

(57) ABSTRACT

In a method of offering an intelligent personalized learning service to learning participants, a pointer is assigned to each learning object and associated with each learning object belonging to a learning object database. A learning subject specific to each learning participant is selected from a learning subject database. Information on attempts at the learning objects associated with selected learning subject is recorded on learning history information of each learning participant. Performance completion information is recorded with respect to the learning objects attempted by the learning participant on the learning history information of each learning participant. A proficiency status of the learning participant is diagnosed for the selected learning subject corresponding to the learning participant based on the learning history information of each learning participant.

### TECHNICAL FIELD

The present disclosure relates to an intelligent personalized learning service method. More particularly, the present disclosure relates to an intelligent personalized learning service method for providing learning participants at learning participant terminals having an internet accessibility with a personalized learning service from a server and a learning object database and a learning subject set database both inter-working with and installed in the server, the method including: assigning a pointer to each of learning objects, the pointer pointing to a learning subject associated with each learning object belonging to the learning object database stored in the databases; recording learning participant-specific learning history data for the learning subjects belonging to a learning area group for said each of the learning objects stored in the databases; computing how the learning participants perform on the learning objects carried out with the learning participant terminals as to whether there are trials and achievement of a number of divided object sections of the learning objects, by using a pre-installed program on the server, and storing a generated calculation into the learning participant-specific learning history data; diagnosing performance on each learning object carried out with the learning participant terminals as to a proficiency state of the learning participant for the learning area group for each of the learning objects based on the learning participant-specific learning history data stored in the databases; and deducing and presenting individual member learners' advancing information from a generated diagnosis by the server.

### BACKGROUND ART

The statements in this section merely provide background information related to the present disclosure and may not constitute prior art.

The problems expected to be solved by the m-learning (mobile learning) or u-learning (ubiquitous learning) services using Internet involve improved personalized educations as well as the omnipresence learning simply. To achieve this, it is necessary to have functions of diagnosing individuals' learning capacities and characteristics by using terminals and managing the student's learning activities based on self-diagnosis and diagnosis result for the achievement completion and weakness and eventually providing an optimal learning plan to enhance the efficiency of learning. However, no apparent technical or methodical solutions have been materialized over the globe besides the in-person teaching of teaching experts such as school teachers.

The present disclosure concerns to solve a deficiency associated with providing various types of learning objects to manage the learning process of students specifically and to diagnose the learning status. Further, the learning service that thoroughly depends on video lectures by VOD (video on demand) is generally not designed to properly bring online the offline provisions of the learning objects in situ such as test questions, explanation of problem solving, and interactive classes. Such a flat delivery of Internet lecture depending entirely on the ability of lecturer and unilaterally providing standardized learning objects to all users is short of systematically providing an intelligent/personalized education service upon the individual characteristics, which is to be a main focus of an e-learning model to take advantage of the recent advancement of information technology.

### DISCLOSURE

### Technical Problem

Therefore, the present disclosure seeks to offer an intelligent personalized learning service method, which analyzes and diagnoses the learning status of students in a learning area group by learning history management of the learning objects for each student under the environment providing various types of learning objects such as lecture video, test questions, problem solving, interactive learning within the learning area provided by the wire/wireless Internet, and provides an intelligent personalized learning service which can enhance the efficiency of learning based on both the analysis result and the diagnosis result.

The present disclosure seeks to offer an intelligent personalized learning service method, which installs, in a database of a server, various learning functions such as a learning subject set, a learning subject grouping by similarity, subsumption relations of subjects among learning subjects, relative importance for learning subject, and prerequisites among learning subjects to provide an intelligent personalized learning service, and deduces and suggests a learners' advancing information of each learning participant.

The present disclosure seeks to offer an intelligent personalized learning service method, which installs, in a memory and a database of a server, contents for checking a dependency among learning objects, a score for learning object, a division of each learning object into logical steps, number of trial for learning subject, solution of learning objects and achievement level check, score obtained by type of learning object and achievement level of learning object, while checking learning achievement level of users time to time with the installed program, and deduces and suggests each learning participant-specific advancing information.

### Summary

A technical solution of the present disclosure is to implement a method of offering an intelligent personalized learning service to learning participants at learning participant terminals having internet accessibility with a personalized learning service from a server and a learning object database and a learning subject set database both inter-working with and installed in the server. The method of offering intelligent personalized learning service may include assigning a pointer to each learning object, recording learning participant-specific learning history data, computing how the learning participants perform, and diagnosing performance on each learning object. The pointer may be assigned to each of learning objects, pointing to a learning subject associated with each learning object belonging to the learning object database stored in the databases inter-working with the server. The databases may record learning participant-specific learning history data for the learning subjects belonging to a learning area group for said each of the learning objects stored in the databases. Using a pre-installed program on the server, the way of the learning participants performing on the learning objects may be computed with the learning participant terminals as to whether there are trials and achievement of a number of divided object sections of the learning objects, and the generated calculation is recorded and stored as the learning participant-specific learning history data. The performance on each learning object carried out with the learning participant terminals may be diagnosed as to a proficiency state of the learning participant for the learning area group for each of the learning objects based on the learning participant-specific learning history data stored in the databases. The intelligent personalized learning service method may further include deducing and presenting individual member learners' advancing information from a generated diagnosis by the server.

Another embodiment of the present disclosure provides a method of offering an intelligent personalized learning service which installs, in a memory and database inter-working with a server, various contents such as a learning subject set, a learning subject grouping by similarity, subsumption relations of subjects among learning subjects, relative importance for learning subject, and prerequisites among learning subjects to provide an intelligent personalized learning service, and deduces and suggests a learners' advancing information of each learning participant.

Yet another embodiment of the present disclosure provides a method of offering an intelligent personalized learning service which installs, in a memory and database inter-working with a server, contents for checking a dependency among learning objects, a score for learning object, a division of each learning object into logical steps, number of trial for learning object, solution of learning objects and achievement level check, score obtained by type of learning object and achievement level of learning object, while checking learning achievement level of users time to time with the installed program, and deduces and suggests advancing information of learning.

### Advantageous Effects

According to the embodiment as described above, the intelligent personalized learning service method can analyze and diagnose the learning status of students in a learning area group by learning history management of the learning objects for each student under the environment providing various types of learning objects such as lecture video, test questions, problem solving, interactive learning within the learning area provided by the wire/wireless Internet, and provide an intelligent personalized learning service which can enhance the efficiency of learning based on both the analysis result and the diagnosis result.

Further, the intelligent personalized learning service method can install, in a database of a server, various learning functions such as a learning subject set, a learning subject grouping by similarity, subsumption relations of subjects among learning subjects, relative importance for learning subject, and prerequisites among learning subjects to provide an intelligent personalized learning service, and deduce and suggest a learners' advancing information of each learning participant.

Furthermore, the intelligent personalized learning service method can install, in a memory and a database of a server, contents for checking a dependency among learning objects, a score for learning object, a division of each learning object into logical steps, number of trial for learning subject, solution of learning objects and achievement level check, score obtained by type of learning object and achievement level of learning object, while checking learning achievement level of users time to time with the installed program, and deduce and suggest an information on each learning participant-specific learners' advancing information.

Additionally, the intelligent personalized learning service method can efficiently operate with low-cost learning management possible in the existing college or elementary school, middle school, and high school by automatically and constantly recording the proficiency status of learning participants for each learning course by the analysis and diagnosis program installed in a server without having separate person in charge of evaluation.

Additionally, the intelligent personalized learning service method can easily estimate the standardized ability for learning participants by analysis and diagnosis program installed in a server based on mutual learning object database, mutual learning subject database, and common evaluation method for each learning course.

### DESCRIPTION OF DRAWINGS

FIG. 1 is a block diagram schematically illustrating a system for providing learning through a learning providing server according to one or more embodiments;

FIG. 2 is a diagram illustrating an example of learning subject structuralization according to one or more embodiments;

FIG. 3 is a diagram illustrating a virtual learning subject structure and an importance of learning assigned to each learning subject according to one or more embodiments;

FIG. 4 is a connected diagram illustrating a connection status between a learning object and a learning subject structure according to one or more embodiments;

FIG. 5 is a diagram illustrating steps of learning object and completion rates according to one or more embodiments;

FIG. 6 is a diagram illustrating an example of calculating a proficiency index of a learning subject according to one or more embodiments; and

FIG. 7 is a diagram illustrating an example of calculating a learning priority index calculation example of learning subject according to one or more embodiments.

### DETAILED DESCRIPTION

Some embodiments of the present disclosure provide a method of an intelligent personalized learning service for providing learning participants at learning participant terminals having an internet accessibility with a personalized learning service from a server and a learning object database and a learning subject set database both inter-working with and installed in the server, the method including: assigning a pointer to each of learning objects, the pointer pointing to a learning subject associated with each learning object belonging to the learning object database stored in the databases inter-working with the server; recording learning participant-specific learning history data for the learning subjects belonging to a learning area group for said each of the learning objects stored in the databases, into the databases; computing how the learning participants perform on the learning objects carried out with the learning participant terminals as to whether there are trials and achievement of a number of divided object sections of the learning objects, by using a pre-installed program on the server, and storing a generated calculation into the learning participant-specific learning history data; diagnosing performance on each learning object carried out with the learning participant terminals as to a proficiency state of the learning participant for the learning area group for each of the learning objects based on the learning participant-specific learning history data stored in the databases; and deducing and presenting individual member learners' advancing information from a generated diagnosis by the server.

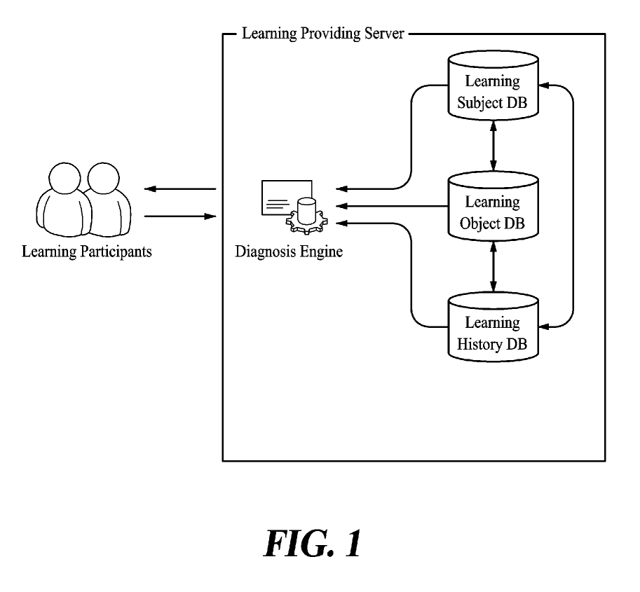

Herein, the details of embodiments of the present disclosure will be described. FIG. 1 is a block diagram schematically illustrating a system for providing learning through a learning providing server according to an exemplary embodiment of the present disclosure. As illustrated in FIG. 1, the learning providing server has a learning subject database, a learning object database, a learning history database, and a database for providing necessary learning to each learning participant and terminal user. The learning providing server further includes an analysis and diagnosis engine having software installed for diagnosing each learning participant.

Terminals, the learning providing server, the diagnosis engine, and the database which are installed in the learning providing system are just logical classification by its functions and roles, and a learning participant's terminal can be implemented to execute a part or whole function of the learning providing server, or it can also be implemented for a great number of people to receive a learning providing service provided from a single server through the respective learning participants' terminals as same as a regular web server.

The composition will be illustrated in detail for providing an intelligent personalized learning service method in accordance with the present disclosure. It starts with [Learning Subject Set Structuralization].

Various content offers to learning participants through their terminals connected with the learning service providing server are realized by the learning service providing server, the database inter-working with the server, and the diagnosis engine program.

A learning subject set is a set of minor learning subjects assigned to the learning participants. For convenience, both a subject and minor learning subjects under the subject are commonly called as the learning subject. Assume that all of assigned learning subject sets have N (number of learning subjects) learning subjects. Mark the learning subject set as ‘SUBJ’, and each learning subject included in the set as ‘subj, then it can be indicated as

SUBJ={subj1, subj2, . . . , subjN}.

Now it will be described for [Structure within a Learning Subject Set].

This is a process of structuralizing a learning subject set. Learning subjects associated by such as similarity of the subject, dependency, and advance learning aptitude can be connected to each other, and can be given a connection intensity among connected learning subjects in level or number value. Learning subjects connected by a pointer are considered to be contiguous. This provides a base for various architectures, but it is assumed for convenience in the present disclosure that the learning subject set has a tree structure in some embodiments. The tree structure is just one example of the learning subject set structure and the scope of the present disclosure is not limited thereto.

The following describes [Learning Subject Grouping by Similar Subject].

It is a way of grouping as one group of learning subjects under the same main theme on the SUBJ, and it can divide SUBJ into several groups in general.

The following describes [Subsumption Relations of Subject among Learning Subjects, Tree Structure].

In each group, the learning subjects can be arranged vertically or horizontally according to the subsumption relations of subject. Therefore, the learning subject structure can naturally have sort of a tree type structure by subsumption relations of the subjects.

Let's call a learning subject playing role of parent node by parent learning subject, and a learning subject playing role of child node by child learning subject. Let's call lineal child learning subjects by sibling learning subject. For example, the learning subject ‘integral calculus’ is a parent learning subject of the learning subject ‘trigonometric function integral’, and ‘trigonometric function integral’ and ‘logarithmic function integral’ are sibling learning subjects of the learning subject ‘integral calculus’. All learning subjects besides the learning subjects on the very top or the very bottom can be both parent learning subject and child learning subject at the same time.

The following describes [Subsumption Relations of Subject Among Learning Subjects, Tree Structure].

The relation existing among the learning subjects includes not only the subsumption relations of the subject. Since acquisition of one learning subject may need advance learning of different prerequisites, advance relation among learning subjects is clarified in learning subject set structuralization.

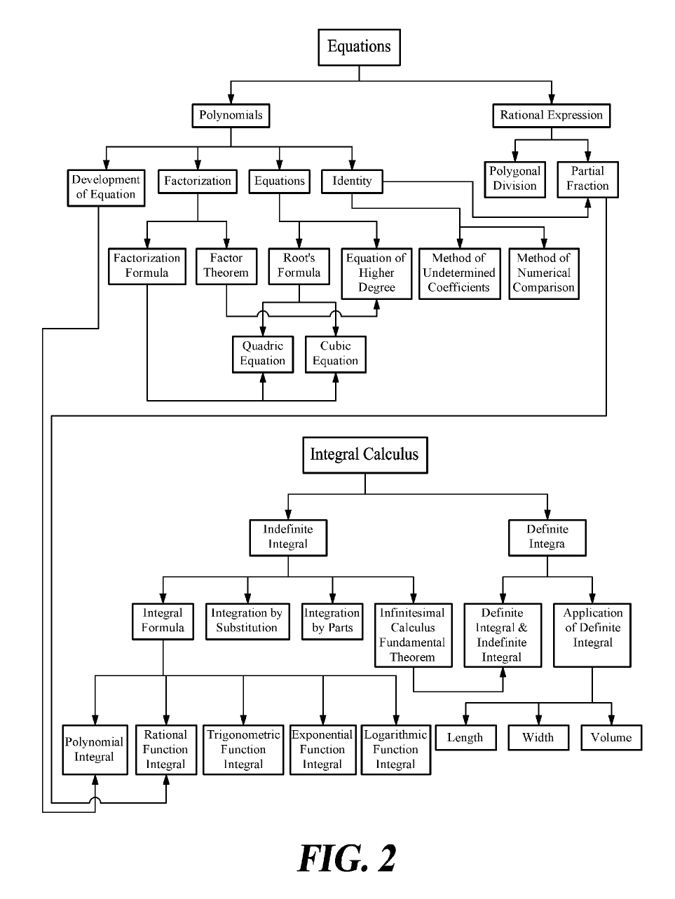

FIG. 2 is a diagram illustrating an example of learning subject structuralization, suggesting a structured math-associated learning subject set which includes two groups. It has similar structure as contents of typical learning materials. The learning subjects connected by branches represent that they are in relation of parent-child, and they are in prerequisite relation of learning.

Each learning subject is assigned the importance of learning for suggesting relative degree of importance in comparison with other learning subjects. If learning subject set is in a tree structure, then the importance of learning(=b(subj)) of assigned learning subject(=subj) can be explained as suggesting a relative weight that each lineal child learning subject takes when acquiring content of parent learning subject, or as suggesting an order of priority in learning. The importance of learning can be expressed by a number value or a level. When expressed by a numerical value, the value is to be within the range [0, 1]. As an example of expressing the importance of learning in a level, the importance of learning can be assigned to each learning subject simply in two levels of ‘compulsory’ and ‘elective’. Even if the importance of learning is assigned in a level, it can be converted into a number value as needed. In occasion of the example, the numerical value of ‘compulsory’ may be set higher than the number value of ‘elective’.

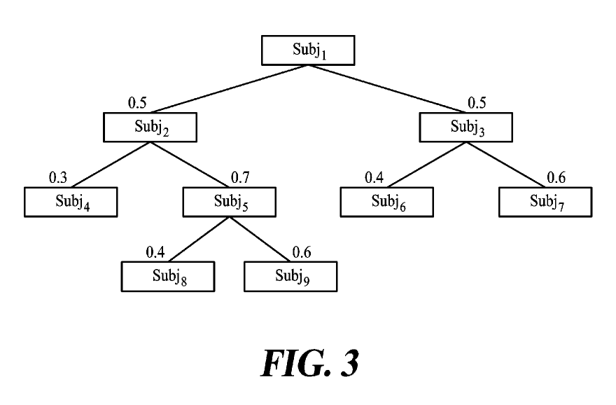

FIG. 3 is a diagram illustrating a virtual learning subject structure and an importance of learning assigned to each learning subject for virtual learning subject set having tree structure.

The following describes [Learning Object] which is key composition element of the present disclosure.

The learning object is divided into three types as follows, considering the learning process composed of total three steps of concept learning step, testing step, and explanation reference step.

The following describes types of learning object.

(Type 1) It is a lecture or a concept presentation for explaining content of learning subject, and it is provided mostly in forms of a video clip, an audio clip, and a flash file format by Adobe Systems corp. in which interactive progress is enabled.

(Type 2) It is a question for knowledge acquisition test and achievement test of learning subject, and mostly provided as combination of a text including numerical formula, symbol, and graph with a picture including figure and diagram.

(Type 3) It is about comprehensive problem-solving, partial problem-solving, comprehensive hint, and partial hint of ‘type 2’ learning object, and is provided as one of or combination of video clip, audio clip, flash, text with picture as in ‘type 1’ and ‘type 2’ learning objects.

The following describes [Dependency of Learning Object].

When dividing types of the learning object as above, one learning object may be seen as being accompanied by subordinates of other learning objects. ‘Type 2’ learning object is subordinate to corresponding ‘type 1’ learning object, and ‘type 3’ learning object is subordinate to ‘type 2’ learning object. Yet ‘type 2’ learning object can be presented independently from ‘type 1’ learning object to the learning participants, but ‘type 3’ learning object cannot be presented until ‘type 2’ learning object is suggested beforehand. Pointer is assigned according to the subordinate relations among learning objects. Namely, pointer is assigned from ‘type 2’ learning object to the associated ‘type 1’ learning object, and from ‘type 3’ learning object to corresponding ‘type 2’ learning object.

The following describes [Learning Subject and Learning Object].

Generally, each learning subject is associated with several learning objects at the same time. Each learning object is assigned a pointer for related learning subject. When a learning subject is connected to a pointer by a certain learning object, then it is considered that they are directly connected. Even if the learning subject is not directly connected to the learning object, but connected to other learning object which is directly connected with the learning object, then it is recognized as being indirectly connected to the learning object. By reciting that assigned learning object is connected to the assigned learning subject, both direct connection and indirect connection are meant to be stated unless otherwise stated. In view of this, the learning subject may be regarded as the keyword for classifying a set of learning objects by subject.

A pointer is assigned to the learning subject associated with the assigned learning object. Numerical value can be assigned depending on the degree of association, and this is called degree of association between learning object (=1) and learning subject (=subj), and is written as symbol of W(I, subj).

Learning subjects connected to the assigned learning object can be arranged by using the degree of association. Assume that assigned learning object (=1) is connected to number K of learning subjects, and these learning subjects are subj1, . . . , subjk. If degrees of association are arranged in descending order like W(subj1, I)≧W(subj2, I)≧ . . . ≧W(subjK, I), then learning subject subj1 has the highest degree of association on learning object I. Subj 2 becomes the learning subject with second highest degree of association. In this case, the learning subject subj1 is called the first priority in degree of association on the learning object I, and the learning subject subj2 is called the second priority in degree of association on the learning object I.

Degree of association is a numerical value assigned relatively on the associated learning subjects, and thus the sum of the assigned degrees of associations is conveniently set to be 1 in total. The abovementioned example used may be expressed as follows.

W(subj1, I)+W(subj2, I)+ . . . +W(subjK, I)=1

Meanwhile, for ‘type 3’ learning object which is completely subordinate to ‘type 2’ learning object, no pointers are assigned to learning subjects.

The following describes [‘type 2’ learning object class].

Some learning objects belonging to ‘type 2’ might have similar formations with each other. For example, some ‘type 2’ learning objects might have essentially similar formations with each other besides some words or numerical values. A set from collecting ‘type 2’ learning objects of same category is called ‘type 2’ learning object class.

A typical example of learning object class may be as follows. Generally, learning objects of same category can have same shape, and in this case it is to be called as ‘learning object framework’, and learning object having the same shape is to be called as ‘instance of the learning object framework’. For example, “Develop the equation of (2x+3y)(x−y)” and “Develop the equation of (2x−y)(2x+y)” are ‘type 2’ learning objects of same category, and they are an instance of learning object framework “Develop the equation of (□x+□y)(□x+□y)”.

When a learning participant tries the learning object class, an instance of learning object may be presented with □ value predetermined by an education expert, or an instance of learning object can be presented with □ value generated randomly within the suitable range.

In view of the above statement, when referring to a “learning object” in the present disclosure, it appropriately means an individual learning object or a learning object class.

The following describes [Learning Objects Scores and Importance of Learning].

Learning objects scores (=s) is level or numerical value assigned to learning object to estimate proficiency of learning participant or solving ability of the participant on the associated learning subject, and is regarded mostly as parameter describing the difficulty level. Score can be assigned to both ‘type 1’ and ‘type 2’ learning objects, but it is mostly assigned to ‘type 2’ learning object for explanation.

Meanwhile, besides assigning the score, importance of learning is also assigned to learning object as it is with learning subject. Importance of learning of learning object can make importance of learning of connected learning subject follow, and have it independently from learning subject. As an example of following importance of learning of learning subject, if it is connected to any learning subject having level of ‘elective’, then the learning object automatically gets level of ‘elective’.

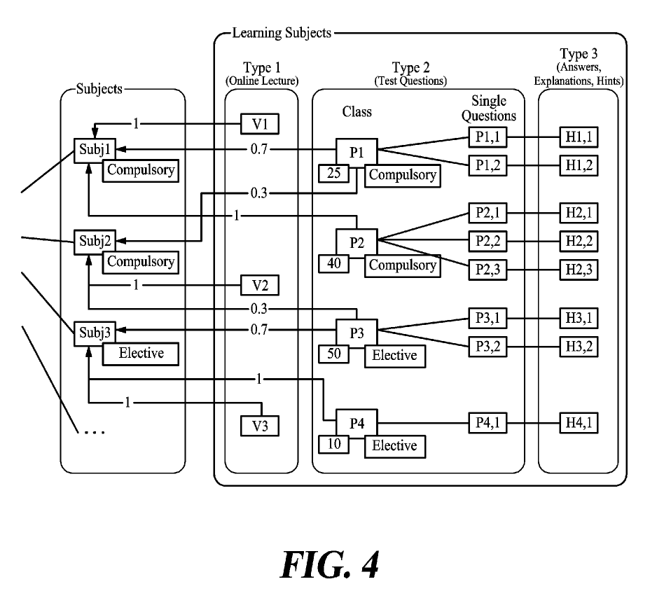

FIG. 4 is a connected diagram of an imaginary case illustrating a connection status between a learning object and a learning subject structure. In FIG. 4, a node starting with subj indicates a learning subject, a node starting with V indicates ‘type 1’ learning object, a node with P indicates ‘type 2’ learning object, and a node with H indicates ‘type 3’ learning object. In case of ‘type 2’, learning object is shown classified by learning object class and corresponding individual learning object. Each learning object, besides ‘type 3’ learning object indicating each learning subject, is connected with associated learning subject in a line, and degree of association is assigned in numerical value. Either ‘compulsory’ or ‘elective’ suggesting importance of learning is marked on the node suggesting the learning subject, and scores are assigned on the left side of the node suggesting ‘type 2’ learning object, and importance of learning is assigned on the right.

Described next is [Session and Achievement Point of Learning Object]. The period from the start of learning participant's trial for one learning object to the end of the learning is called a session for the learning object or simply called a session. In the case of ‘type 1’ learning object for one assigned learning object, when a learning participant plays one learning object from the beginning and reaches to the ending part, then the achievement point is said to be reached. In the case of ‘type 2’ learning object, when the learning participant finds the correct answer of learning object in the learning, then the achievement point is considered that it has reached the achievement point. ‘Type 3’ learning object has no concept of achievement by definition.

The following is [Achievement Completion Information of Learning Participant on Learning Object]. It is information about how far a learning participant has reached from the beginning of learning object based on the achievement completion point of learning object and about how the learning participant has reached the arrival point. The concept of completion rates is used to calculate the former. The completion rates may be expressed in a level or numerical value, and the completion rates are assigned as an example, for convenience, using a real number of minimum value of 0, and maximum value of 1 in some embodiments.

Assume that learning object is logically composed of several steps to calculate the completion rates. (Also including the case composed of only one step.) The achievement rate (=r) is assigned to each step, and in this occasion the completion rate of the learning objects is defined as sum of all achievement rates of steps which are completed by the learning participant. Generally a learning participant can be considered to have a higher achievement ability for reaching the achievement completion point at once than through several steps, so the completion rate may be less than or equal to 1 in the latter case. Namely, when giving achievement rate to each step for one learning object, the sum of all the achievement rates of steps does not go over 1. The achievement rate in learning object including only one step is 1.

When the case of ‘type 1’ learning object is not logically classified into several steps, then the completion rates can be calculated by arbitrarily dividing total running time interval into several sub-intervals and giving achievement rate to each sub-interval. Even though it is not divided into several sub-intervals, the achievement rate can be determined with the ratio of the actual viewing range or listening range to the total time interval.

In case of ‘type 2’ learning object, the learning participant can refer to associated ‘type 3’ learning object, which is hint or explanation, before reaching the achievement completion point. In this case, the value of the completion rate in calculation is adjusted down with a penalty applied for the referencing. For example, the completion rates are calculated by lowering the value of achievement rate of the step to which the referred hint or explanation belongs below its originally assigned value. In addition, when the learning participant has spent a lot of time in solving ‘type 2’ learning object, i.e., when the session is long, then the completion rates are calculated with the penalty applied.

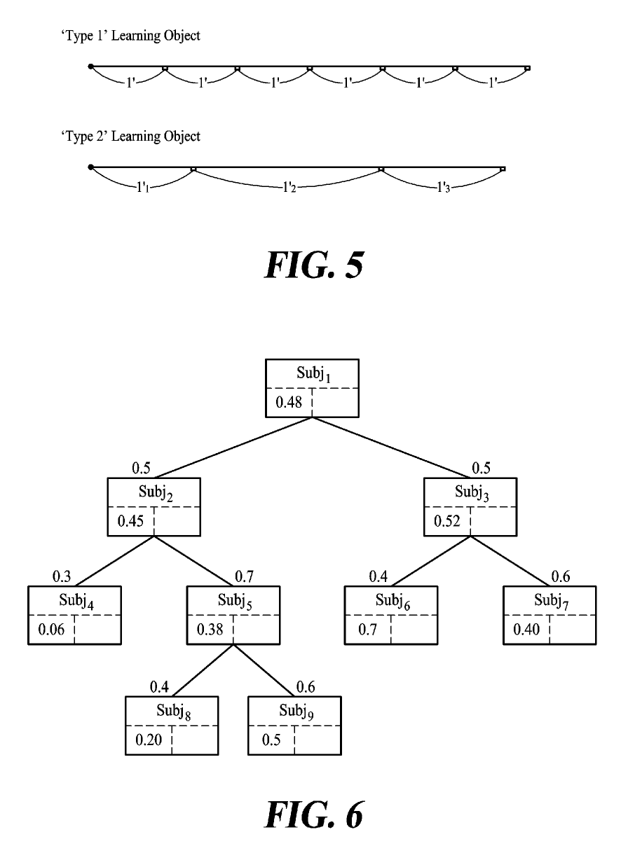

FIG. 5 is a diagram for illustrating several divided steps of a learning object and a completion rate given to each step. The first straight line is an example of ‘type 1’ learning object, and, in here, given running time interval is divided into sub-intervals having same length, and the same achievement rate is assigned to each sub-interval. The second straight line is an example of ‘type 2’ learning object, and here it is divided into 3 steps. If a learning participant has solved up to the first two steps of the learning object, and read the explanation for the remainder, then the third step is considered as being unsolved so the completion rate is calculated as r1+r2.

The following describes [Trial Numbers of Learning Object]. The trial numbers of learning participant in ‘type 1’ learning object, mean the total number of the learning participant's viewing or listening.

The trial numbers of learning participant on ‘type 2’ learning object mean, in some cases, the trial number of learning object class of the learning object. For example, if there are ‘type 2’ learning objects having same class relation on the assigned learning object, and a learning participant has attempted k time(s) in total with or without overlapping among the learning objects, then it is considered that the learning participant has attempted k time(s) on the learning object class of the ‘type 2’ learning object.

The following describes [Completion Rates Update Upon Re-trial of Learning Object]. A learning participant tries one learning object for several times if necessary. If the learning participant has attempted a single assigned learning object for several times, then new completion rate on the learning object can be the completion rate of newest trial, or new completion rate can be determined by considering all completion rates of the past trials.

The next describes [Completion Rate Update By Lapse of Time].

If the participating period of a learning participant is long, then the fluency of the learning participant may be decreased on the learning object or learning object class of the past trial, so the completion rates can be reduced gradually by considering time interval from last trial to recent trial.

Examined next is [Learning Participant-specific Learning History Data].

The following description is for learning area establishment associated to learning participant-specific learning history data. The learning area may be established in advance depending on learning participant group or it can be designated directly by individual learning participant. Here, the learning area is to be seen as a subset of assigned learning subject set SUBJ, and to be marked as RSUBJ. Namely, the learning area in the present disclosure means learning subjects that a learning participant will learn about.

Examining next [Learning Participant-specific Learning History Data], it is data including learning records on learning subjects included in learning area RSUBJ and associated learning objects during the participation of a learning participant.

Each learning participant can have many pieces of learning participant-specific learning history data, but data on learning participant's accumulated trials of learning objects associated with learning subjects is used as the main learning history data. The data on accumulated trials includes information about
whether there are trials,
the number of trials,
beginning time of each trial,
amount of time until the stop of each trial,
and achievement completion-related information of each trial.

The next is [Learning Diagnosis].

The learning diagnosis in some embodiments includes a degree of proficiency on each learning subject of a learning participant and an estimation of basic knowledge acquisition degree.

The next is [Estimation for Degree of Proficiency and Basic Knowledge Acquisition]. The concept of learning subject-specific index for proficiency is introduced to estimate the degree of proficiency. The learning subject-specific index for proficiency is a numerical value assigned to each learning subject, and suggests information that how proficient the learning participant is on corresponding learning subject (=subj), and is marked as D(subj). Consequently, whether learning participant is proficient or not on assigned learning subject is determined by the index for proficiency, and if it exceeds pre-set threshold, then the participant is judged proficient, otherwise illiterate.

Similarly, the concept of knowledge acquisition index for high priority topics by learning subject can be introduced to estimate the degree of basic knowledge acquisition, and it notifies the information, in a numerical value, about how much a learning participant has really acquired on knowledge of assigned learning subject that basically needs to be acquired. The knowledge acquisition index for high priority topics differs from the index for proficiency in that it deals with only the learning objects having high importance of learning, but besides that, the rest is practically same, therefore details of the index for proficiency will be described next.

The following description is for [Method of Determining Index for Proficiency].

There are roughly two methods of determining the index for proficiency on the learning subject. First one is a method (=MD1) of giving the index based on learning history data of learning participant on learning objects associated with assigned learning subject, and second one is a method (=MD2) of determining the index from index for proficiency of other learning subjects besides the learning subject.

[MD1] suggests a method in which index for proficiency is determined based on the learning history data of the learning participant. In this case, the index for proficiency is valued high as with an increase of the completion rate of associated learning object, namely, the index for proficiency is a function for the completion rate of learning participant for each learning object linked to the learning subject, and is expressed as a function such as f(C1, C2, . . . , Cn) and is defined as an increasing function for each completion rate Ci(i=1, . . . , n), wherein there are number n of the learning objects linked to the learning subject and the completion rate for each learning object is expressed as C1, C2, . . . , Cn.

If degree of association and scores for n learning objects are assigned respectively as W1, . . . , Wn, and S1, . . . , Sn, then the index value for proficiency gets higher as the degree of association and the scores become greater. Namely, the index for proficiency is a function for completion rates C1, . . . , Cn having the degree of association W1, . . . , Wn and the scores S1, . . . , Sn as parameter. Therefore, the index for proficiency can be expressed as f(C1, . . . , Cn; W1, . . . , Wn; S1, . . . , Sn). The degree of association and the scores are treated as parameter since there are many cases that they are independently predetermined by learning participant. (But it is only an example, and the parameters do not need to be independent from learning participant.)

Linear combinations for completion rates of learning object can be a concrete example of index for proficiency same as above. Namely, it can be formed as f(C1, . . . , Cn; W1, . . . , Wn; S1, . . . , Sn)=Z1*W1*S1*C1+. . . +Zn*Wn*Sn*Cn on real number Z1, . . . , Zn which is not negative number. PM; Each Zi (i=1, . . . , n) can be determined by reflecting trial data such as the number of trial on each i-th one of learning objects and time spent on completion, and can be also determined to standardize values with comparison among indexes of proficiency, so that they remain within the range [0,1] as an example.

An example of index for proficiency in function form same as above is as follows. To this end, accumulated trial grade (=A) and accumulated acquisition grade (=E) are calculated. When learning object(=I) is attempted by the learning participant, the accumulated trial grade and accumulated acquisition grade are calculated as follows for learning subject(=subj) associated with the learning object.

New accumulated trial grade(=A′)=existing accumulated trial grade(=A)+S(I)×W(I, subj);

New accumulated acquisition grade(=E′)=existing accumulated acquisition grade(=E)+C(I)×S(I)×W(I, subj).

This is a base for defining the index for proficiency as follows. When M is defined as a sum adding all products of score and degree of association for each learning object associated with corresponding learning subject, index for proficiency is formulated as follows when F=(A×A)/(M×M), G=E/A and is defined as D(subj)=F×G.

D(subj)=(A×E)/(M×M)

The index for proficiency is always within the range [0, 1], and is expressed as linear combination for the aforementioned completion rates.

Now as for [MD2], a description will follow on a method of getting index for proficiency for assigned learning subject from index for proficiency of other learning subjects. This method is mostly used when assigned learning subject have no directly connected learning object for calculating the learning object from indexes for proficiency of other associated learning subjects which is calculated in advance. It is determined by a weight average on the indexes for proficiency of the other associated learning subject.

A learning subject set is conveniently assumed to have a tree structure to give a concrete example. In this case, each learning subject has parent learning subjects or child learning subjects. Index for proficiency of each learning subject can be determined from index for proficiency of the parent learning subjects and the child learning subjects. An example of getting the index for proficiency from lineal child learning subjects is as follows. The index for proficiency of the assigned learning subject is calculated by weight average of indexes for proficiency of lineal child learning subjects. Here, weight in calculating the weight average is an importance of learning of each child learning subject. Assuming that the assigned learning subject (=subj) has K pieces of lineal child learning subject subj1, subj2, . . . , subjK, then index for proficiency for learning subject subj is given as D(subj)=b(subj1)*D(subj1)+b(subj2)*D(subj2)+ . . . +b(subjK)*D(subjK), and b(subj1), . . . , b(subjK) mean importance of learning which is possessed by each child learning subject subj1, . . . , subjK.

If the importance of learning is a positive number meeting equation of b(subj1)+ . . . +b(subjK)=1, and if index proficiency of each child learning object D(subj1), . . . , D(subjK) is included in the range [0,1], then index for proficiency D(subj) which is calculated as described above is also included in the range [0,1].

A point to note here is that though MD2 gets index for proficiency from index for proficiency of the other learning subject, the calculation result is similar to the result by function f(C1, . . . , Cn; W1, . . . , Wn; S1, . . . , Sn) in MD1.

As for [Index for Proficiency Update Spread], if one learning object is attempted by a learning participant, then corresponding index for proficiency of each of all learning subject connected through the aforementioned methods can be updated, and this is called the index for proficiency update spread. The index for proficiency update spread is performed by simply calculating, with MD1, the index for proficiency on each of all learning subjects within learning area which are connected with the attempted learning object. Or the index for proficiency update spread can be performed by first dividing all learning subject within the learning area into two groups and then calculating, with MD1, the index for proficiency of learning subject belonging to a first group, and by calculating, with MD2, the index for proficiency of learning subject belonging to a second group. Whenever learning object is attempted, the spread can be performed overall, or the spread can be performed at once by reflecting previous attempts on certain amount of learning objects. Both cases are similar so it is assumed that index for proficiency update spread of associated learning object is performed right after one learning object is attempted.

To give an example for convenience, assume that learning subject set has the tree structure, and arbitrary child node has only one lineal parent node, and learning objects are connected with only leaf node learning subjects. Let's say K is the number of all leaf node learning subject indicated by learning object (=item) which is attempted by learning participant, and these are subj1, subj2, . . . , subjK. First update is carried out on the index for proficiency of the K learning subject(s) with MD1, and next update is carried out on index for proficiency on parent learning subject of learning subject subj1 with MD2.

If the parent learning subject is not top node, then it is updated by using MD2 until process such as updating index for proficiency of parent learning subject for the parent learning reaches top node. Next, overall index for proficiency update is completed by repeating the same process of learning subject subj1 for rest of learning subjects subj2, . . . , subjK located in the leaf node.

FIG. 6 is a diagram for illustrating an example of calculating a proficiency index of a learning subject for virtual learning subject set having the tree structure. Importance of learning is assigned above each node. When assuming that index for proficiency of learning subject in leaf node is assigned, index for proficiency of learning subject in each parent node is calculated as weighted average (weight is importance of learning) of index for proficiency of lineal child node. For example, index for proficiency of subj5 is a weight average on index for proficiencies 0.2 and 0.5 of subj and subj which are the lineal learning subjects. Namely, index for proficiency of subj5 is calculated as 0.38=0.4*0.2+0.6*0.5.

The following describes [Learning Advancing/Direction Suggestion].

When diagnosis is performed based on learning history of a learning participant, index for proficiency for all learning subjects included in learning area RSUBJ cab be calculated. A method is suggested for giving the learning participant a learning direction which is to be followed. Learning direction in the present embodiment means the order of learning subjects to be learned by a learning participant from a diagnosis on the current degree of proficiency.

Learning direction is suggested according to a learning goal of a learning participant. Assuming the learning goal of a learning participant is to improve the degree of proficiency of set learning area, an example of generating learning direction will be provided by using index for proficiency.

As to [Learning Order Determination Through Learning Priority Index], learning priority index according to each learning subject-specific degree of proficiency is calculated. The learning priority index is a numerical value showing the degree which has to be learned first for efficient learning of a learning participant. The learning priority index (=L(subj)) according to the degree of proficiency of learning subject(=subj) is seen as a function on importance of learning and index for proficiency of the learning subject, and selections are made for a decreasing function in terms of index for proficiency and a increasing function in terms of importance of learning. As a simple example of learning priority index, and there is L(subj)=b(subj)/D(subj).

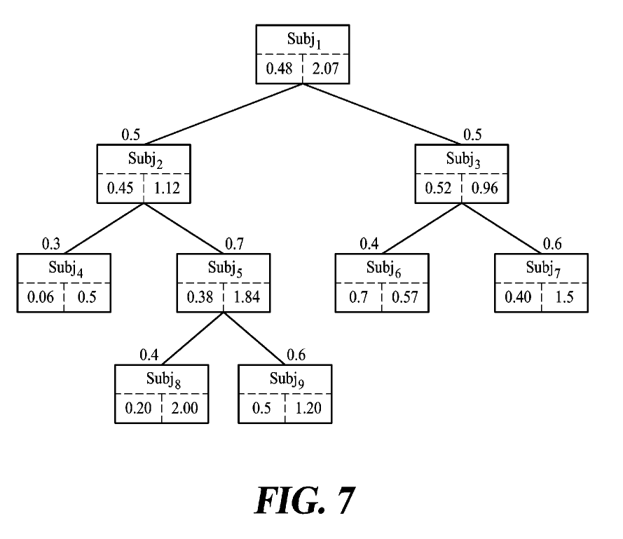

In FIG. 7, right numerical value of each node is about learning priority index on each learning subject. The learning priority index is calculated by the ration of the importance of learning to the index for proficiency as described above. Order of learning priority can be obtained with the use of the learning priority index. The learning priority index of subj2 is 1.12 and thus higher than the learning priority index of subj3 which is 0.96. Likewise, a comparison between subj8 and subj9 will tell the learning priority of subj8 is as high as 2 over the learning priority 1.2 of subj9.

The following describes [Learning Subject-specific Associated Learning Object Learning Order Determination]. Determination may be also made on the order of learning object which will be suggested to learning participants based on the diagnosis on each learning subject.

Each learning object is associated with several learning subjects, and the learning objects are classified by the assigned learning subject into a first set of learning objects with the highest relevance to the subject followed by a second closest set of learning objects and so on with a closer set placed ahead in arrangement. In each learning object set arranged by the ranking of relevance, the learning objects are arranged in descending order according the importance of learning. For example, when the importance of learning is divided into ‘compulsory” and ‘elective’, learning objects having ‘compulsory’ level may be located ahead in the order of arrangement. Learning objects that were attempted for each level in the past and have completion rates below standard are gathered and arranged in ascending order on completion rates, and learning objects that were not attempted in the past are arranged right behind them. At last, learning objects with same completion rates are arranged in ascending order on the score. In addition, learning objects that were not attempted in the past are arranged in ascending order on the score. To summarize, the arranging standard and arrangement direction in each step are;

\textcircled{1} ranking of relevance to assigned learning subject, in ascending order

\textcircled{2} importance of learning, in ascending order

\textcircled{3} completion rates, in ascending order

\textcircled{4} score, in ascending order.

The following describes [Parameter Value Tuning Through Statistical Processing]. As used in some embodiments, the parameters, importance of learning (=b) of learning subject, degree of association (=W) between learning subject and learning object, score (=S) of learning object, and achievement rate (=r) assigned to each learning object are determined independently from or dependently to the learning participant by various factors.

The factors for determining values of the parameters are difficulty levels of learning subject, level of learning participant, goal of learning participant, and achievement degree of learning participant within the assigned period. Based on the factors, the parameter values that are proper to each learning participant can be found by tuning values of the parameters regularly through statistic and computational technique such as regression analysis, neural network, and machine learning.

The terms upon the embodiments are as follows:

Key Terms
Intelligent personalized learning
Learning subject set (=SUBJ)
Learning area (=RSUBJ)
Learning subject structure
Subsumption relations of subjects
Advance learning aptitude
Importance of learning (=b(subj))
Learning objects (=I)
Learning objects (=I) scores (=S)
Associated weights (=w (I, subj)) between learning objects (=I) and learning subjects (=subj)
Learning object class
Completion rates (=C) of learning objects (=I)
Learning participant-specific learning history data
Data on accumulated trials of learning subjects
Index for proficiency (=D(subj)) for learning subjects (=subj)
Learning priority index (=L(subj))
Parameter tuning

### INDUSTRIAL APPLICABILITY

The present disclosure is highly useful for industrial applicability since it provides an intelligent personalized learning service method which is composed of steps of deducing and presenting individual member learners' advancing information based on the diagnosis result diagnosed from the server.

1. A method of offering an intelligent personalized learning service from a server to learning participants through learning participant terminals, the server inter-working with a database which includes a learning object database and a learning subject database, the method comprising:
assigning a pointer to each of learning objects, the pointer pointing to a learning subject associated with each learning object belonging to the learning object database stored in the database inter-working with the server;
selecting learning subjects specific to each learning participant from the learning subject database;
recording information on attempts at the learning objects selected from the learning objects stored in the database and associated with selected learning subjects, as a learning history information of each learning participant;
recording and storing a performance completion information with respect to the learning objects attempted by the learning participant through a learning participant terminal, as the learning history information of each learning participant; and
diagnosing a proficiency status of the learning participant for the selected learning subjects corresponding to the learning participant based on the learning history information of each learning participant recorded and stored in the database.

2. The method of claim 1, wherein the process of diagnosing the proficiency status for the learning subjects is performed by giving a proficiency index for representing a proficiency level of the learning participant for each learning subject onto the learning subject.

3. The method of claim 2, wherein the process of diagnosing the proficiency status for the learning subjects comprises setting an order of learning subjects for the learning participant by first assigning a proficiency index to each learning subject and then further assigning a learning priority index to said each learning subject by said each learning participant and thereby quantitatively comparing between learning priority indexes.

4. The method of claim 3, wherein the learning priority index assigned to said each learning subject by said each learning participant is a decreasing function for a corresponding proficiency index in case a difficulty characteristic and/or an importance characteristic of the learning subject are fixed as parameters.

5. The method of claim 4, wherein the learning priority index assigned to said each learning subject by said each learning participant for said each learning subject is determined as an increasing function for the importance characteristic of a corresponding learning subject in case there is a level assigned for representing the importance characteristic or a numerical value assigned for representing the importance characteristic and the proficiency index is fixed.

6. The method of claim 5, wherein the learning priority index assigned to said each learning subject by said each learning participant for said each learning subject is determined by dividing the importance characteristic of the learning subject by the proficiency index for each learning participant of the learning subject.

7. The method of claim 2, wherein the proficiency index of said each learning subject of said each learning participant is a function for a performance completion rate of said each learning participant for said each learning object linked to the learning subject, the proficiency index being expressed as a function of f(C1, C2, . . . , Cn) where n is the number of the learning objects linked to the learning subject, and the performance completion rate for said each learning object is expressed as C1, C2, . . . , Cn with each performance completion rate Ci(i=1, . . . , n) comprising the increasing function.

8. The method of claim 7, wherein for the purpose of calculating the performance completion rate of said each learning object with the performance completion rate comprising the increasing function, the learning object either comprises one step having a performance rate assigned or is divided into two or more logical steps having performance rates assigned.

9. The method of claim 1, wherein the performance completion rate of said each learning object of said each learning participant is calculated by tallying the performance ratios assigned to steps completed by the learning participant.

10. The method of claim 9, wherein the performance completion rate of said each learning object of said each learning participant is determined by a performance completion ratio of a learning object class including the learning object.

11. The method of claim 8, wherein the proficiency index of said each learning subject of said each learning participant is determined by calculating proficiency indexes of other learning subjects than said each learning subject.

12. The method of claim 11, wherein the proficiency index of said each learning participants is determined by using a weight average in the calculating of the proficiency indexes of the other learning subjects than said each learning subject.

13. The method of claim 12, wherein a function(f) representing the proficiency index for said each learning subject of the learning participant is a function having a score (Si) as a parameter, the score representing the difficulty characteristic or importance characteristic and being assigned to each i-th (i=1,2, . . . n) one of the learning objects, and the proficiency index is expressed as f(C1, . . . , Cn; S1, . . . Sn) where the performance completion rate is Ci (i=1, . . . , n) and is an increasing function for each parameter valued Si (i=1, . . . , n).

14. The method of claim 13, wherein the function(f) representing the proficiency index for said each learning subject of the learning participant is a function having a degree of association (Wi) as the parameter when the degree of association with the learning subject is assigned to each i-th (i=1, . . . n) one of the learning objects, and the proficiency index is expressed by f(C1, . . . , Cn; W1, . . . , Wn) where the performance completion rate is Ci(i=1, . . . , n), and is the increasing function for each parameter valued Wi(i=1, . . . , n).

15. The method of claim 14, wherein the score (=s), the degree of association (=w), and the importance characteristic of the learning subject (=b) are either irrelevant to levels of said each learning participant or depending on the level of said each learning participant.

16. The method of claim 15, wherein the function(f) representing the proficiency index for said each learning subject of the learning participant is a function for completion rates C1, . . . , Cn having the degree of association Wl, Wn and the scores S1, . . . , Sn as parameters and is expressed as f(C1, . . . , Cn; W1, . . . , Wn; S1, . . . , Sn)=Z1*W1*S1*C1+. . . +Zn*Wn*Sn*Cn where Z1, . . . , Zn comprise non-negative real numbers.

17. The method of claim 16, wherein said each Zi (i=1, . . . , n) is determined reflecting trial data with respect to the learning objects.

18. The method of claim 17, wherein said each Zi (i=1, . . . , n) is determined to have the proficiency index so that all proficiency index values remain in a common range.

19. The method of claim 8, wherein the learning subject is structured as a tree structure having the learning subject as a node, and children nodes of the learning subject are advanced in detail relative to patents nodes of the learning subject.

20. The method of claim 19, further comprising updating the proficiency index of each and all of the learning subjects in a learning subject set having the tree structure, as for the learning object attempted by the learning participant by dividing the learning subject set into two groups of a first group and a second group and then using the function(f) for updating the proficiency indexes of the learning subjects belonging to the first group and using proficiency indexes of other learning subjects than the learning subjects in the first group for updating proficiency indexes of remaining learning subjects belonging to the second group.

21. The method of claim 20, further comprising updating the proficiency index of each and all of the learning subjects in a learning subject set having the tree structure, as for the learning object attempted by the learning participant by connecting all of the learning subjects belonging to the learning object database with only the learning subjects at leaf nodes and including the learning subjects at leaf nodes in the first group and including the remaining learning subjects in the second group.

22. The method of claim 21, further comprising calculating the proficiency of the learning subjects belonging to the second group by using a weighted average of the proficiency indexes of lineal child nodes of the learning subject, wherein calculations of the proficiency indexes spread from the lowest level of the tree structure to the highest level by stages gradually to complete updating the proficiency index of all of the learning subjects.

23. The method of claim 22, wherein the proficiency index of the parent node is calculated by the weighted average for the proficiency index of the lineal child nodes with an weight value determined by the degree of importance of each of the lineal child nodes.

24. The method of claim 19, further comprising updating the proficiency index of each and all of the learning subjects in a learning subject set having the tree structure, as for the learning object attempted by the learning participant by using the function(f) in updating the proficiency index of said each learning subject.

25. The method of any one of claims claim 3 through 6, further comprising arranging the learning subjects respectively by the learning priority index assigned to the learning subjects and arranging the learning objects associated with an arranged learning subject for enabling the learning participants to study an individual selection of the learning objects off the learning participant terminals.

26. The method of claim 25, wherein the learning objects are arranged by criteria comprising ranking of degrees of association with the learning subject, the performance completion rate and the score which are in ascending order respectively to present the learning participants with a choice from the learning objects on the learning participant terminals.

27. The method of claim 9, wherein the learning subject is structured as a tree structure having the learning subject as a node, and children nodes of the learning subject are advanced in detail relative to patents nodes of the learning subject.

28. The method of claim 12, wherein the learning subject is structured as a tree structure having the learning subject as a node, and children nodes of the learning subject are advanced in detail relative to patents nodes of the learning subject.
